(19) United States
(12) Patent Application Publication
(10) Pub. No.: US 2013/0083555 A1
(43) Pub. Date: Apr. 4, 2013

(54) LIGHTUNG MODULE AND ILLUMINANT DECICE HAVING THE SAME

(71) Applicants: Shih-Pin CHEN, Taipei City (TW); Huan-Hsian Huang, Taipei City (TW); Chan-Hung Shao, (US)

(72) Inventors: Shih-Pin CHEN, Taipei City (TW); Huan-Hsian Huang, Taipei City (TW); Chan-Hung Shao, (US)

(73) Assignee: Chicony Power Technology Co., Ltd.

(21) Appl. No.: 13/423,842

(22) Filed: Mar. 19, 2012

(30) Foreign Application Priority Data
Sep. 30, 2011 (TW) 100218320

(51) Int. Cl. F21V 8/00

(52) U.S. Cl. 362/555

(57) ABSTRACT

A lighting module includes an illuminant unit, a light guide pillar and a first reflecting member. The illuminant unit has an optical axis and includes at least a LED. The light guide pillar includes a base and a light guide part, the LED disposed on the base, the light guide pillar is extended from the base along the optical axis and an end of the light guide pillar has a top surface. The top surface is concave toward the base and is continuous. The first reflecting member is disposed on the top surface. Wherein a partial light emitted by the illuminant unit is travelling to the first reflecting member through the light guide pillar, the first reflecting member reflects the partial light such that the partial light emits from the light guide part.

### BACKGROUND OF THE INVENTION

1. Field of the Invention

The present invention relates to an illuminant device, and in particular to an illuminant device having light emitting diode.

2. Description of Prior Art

A light emitting diode (LED) is a kind of semiconductor device, which exploits the property of direct-bandgap semiconductor material to convert electric energy into light energy efficiently and has the advantages of long service time, high stability and low power consumption and is developed to replace the traditional non-directivity light tube and incandescent lamp.

The LED is a point-like light source and has high directivity so that the lighting surface of the LED is narrower than that of the traditional light sources, and the luminous intensity of the LED is gradually reduced while the lighting distance is increased, so that the LED is more suitable for providing short-distance and small area lighting fixture, such as table lamp.

In order to apply LEDs into other luminaire, such as light bulbs or candlelight, most companies assemble and arrange multiple LEDs to solve the problem of smaller lighting range. However, the power is increased when the number of the LEDs is increased and cannot achieve energy saving, and the price of the LED luminaire is higher than traditional light source. This reduces the will of users to use LED luminaire.

### SUMMARY OF THE INVENTION

It is an object of the present invention to provide a lighting module to effectively enlarge the lighting angle of light passing through.

It is another object of the present invention to provide an illuminant device to effectively enlarge the lighting angle of light passing through.

Accordingly, the lighting module according to one aspect of the present invention comprises an illuminant unit, a light guide pillar and a first reflecting member. The illuminant unit has an optical axis and comprises at least a light emitting diode (LED). The light guide pillar comprises a base and a light guide part extended from the base along the optical axis, an extension end of the light guide part has a top surface concave toward the base and being continuous. The first reflecting member is disposed on at least portion of the top surface. Wherein a partial light emitted by the illuminant unit is travelling to the first reflecting member through the light guide pillar, the first reflecting member reflects the partial light such that the partial light emits from the light guide part.

Accordingly, the illuminant device according to another aspect of the present invention comprises a housing, a lighting module, a shell and a conductive connector. The lighting module is disposed on the housing and comprises an illuminant unit, a light guide pillar and a first reflecting member. The illuminant unit has an optical axis and comprises at least an LED. The light guide pillar comprises a base and a light guide part extended from the base along the optical axis, an extension end of the light guide part has a top surface concave toward the base and being continuous. The first reflecting member is disposed on at least a portion of the top surface. The shell is assembled with the housing such that the lighting module is arranged between the shell and the housing. The conductive connector is physically connected to the base and opposite to the shell. Wherein a partial light emitted by the LED is travelling to the first reflecting member through the light guide pillar, the first reflecting member reflects the partial light such that the partial light emits from the light guide part and transmits to and emits by the shell.

In the present invention, the light guide pillar of the lighting module to change the travelling route of light, thereby enlarge the light-emitting angle of light passed through the light guide pillar and fit into ordinary luminaire.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a perspective view of an illuminant device according to a first preferred embodiment of the present invention.

FIG. 2 is a cross sectional view of the illuminant device according to the first preferred embodiment of the present invention.

FIG. 3 is a cross sectional view of a lighting module according to the first preferred embodiment of the present invention.

FIG. 4 is a perspective view of a light guide pillar according to the first preferred embodiment of the present invention.

FIG. 5 is a schematic view of the luminous distribution of light passing through the light guide pillar according to the first preferred embodiment of the present invention.

FIG. 6 is a schematic view of the luminous distribution of light passing through the lighting module according to the first preferred embodiment of the present invention.

FIG. 7 is a perspective view of a light guide pillar according to a second preferred embodiment of the present invention.

FIG. 8 is a schematic view of the luminous distribution of light passing through the light guide pillar according to the second preferred embodiment of the present invention.

FIG. 9 is a perspective view of a light guide pillar according to a third preferred embodiment of the present invention.

FIG. 10 is a schematic view of the luminous distribution of light passing through the light guide pillar according to the third preferred embodiment of the present invention.

FIG. 11 is a cross sectional view of a lighting module according to a fourth preferred embodiment of the present invention.

FIG. 12 is a cross sectional view of a lighting module according to a fifth preferred embodiment of the present invention.

FIG. 13 is a schematic view of the luminous distribution of light passing through the illuminant device according to the first preferred embodiment of the present invention.

FIG. 14 is a perspective view of a lighting module according to a sixth preferred embodiment of the present invention.

FIG. 15 is a schematic view of the luminous distribution of light passing through the lighting module according the sixth preferred embodiment of the present invention.

FIG. 16 is a perspective view of a light guide pillar of a seventh preferred embodiment of the present invention.

FIG. 17 is a perspective view of a light guide pillar of an eighth preferred embodiment of the present invention.

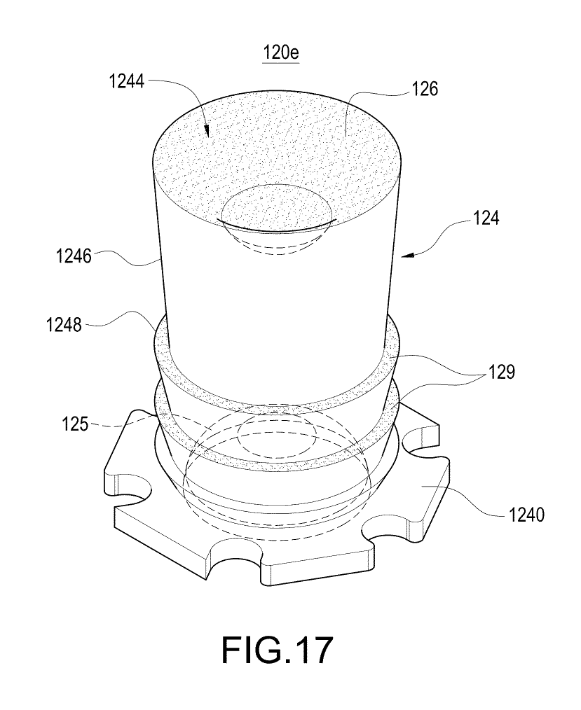

FIG. 18 is a cross sectional view of an illuminant device of a second preferred embodiment of the present invention.

FIG. 19 is a perspective view of a lighting module according to a fourth preferred embodiment of the present invention.

FIG. 20 is a schematic view of the luminous distribution of light passing through the light guide pillar shown in FIG. 18.

FIG. 21 is a schematic view of the luminous distribution of light passing through the illuminant device according the second preferred embodiment of the present invention.

### DETAILED DESCRIPTION OF THE INVENTION

Reference will now be made in detail to the present embodiments of the invention, examples of which are illustrated in the accompanying drawings. Wherever possible, the same reference numbers are used in the drawings and the description to refer to the same or like parts.

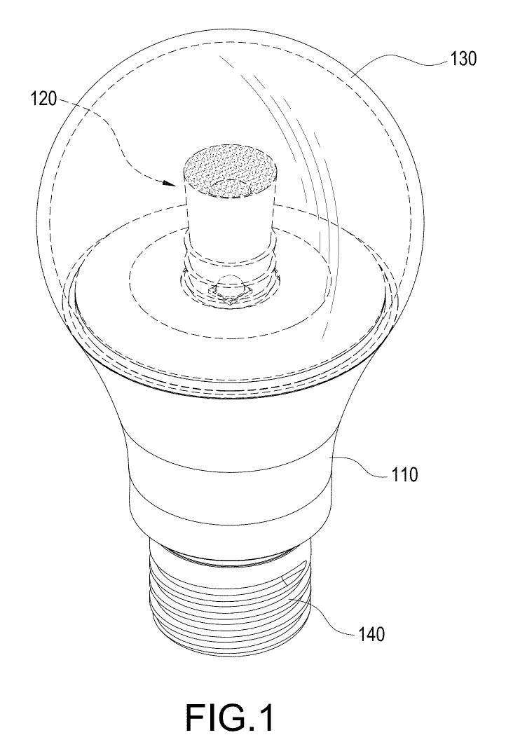

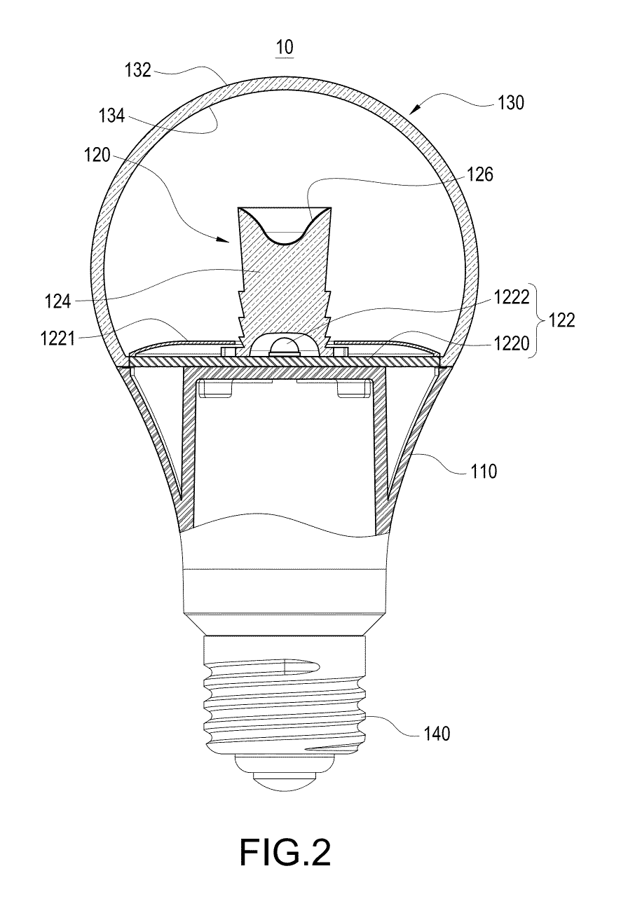

Reference is made to FIG. 1 and FIG. 2, which are respectively a perspective view and a cross sectional view of an illuminant device according to a first preferred embodiment of the present invention. The illuminant device 10 includes a housing 110, a lighting module 120, a shell 130 and a conductive connector 140.

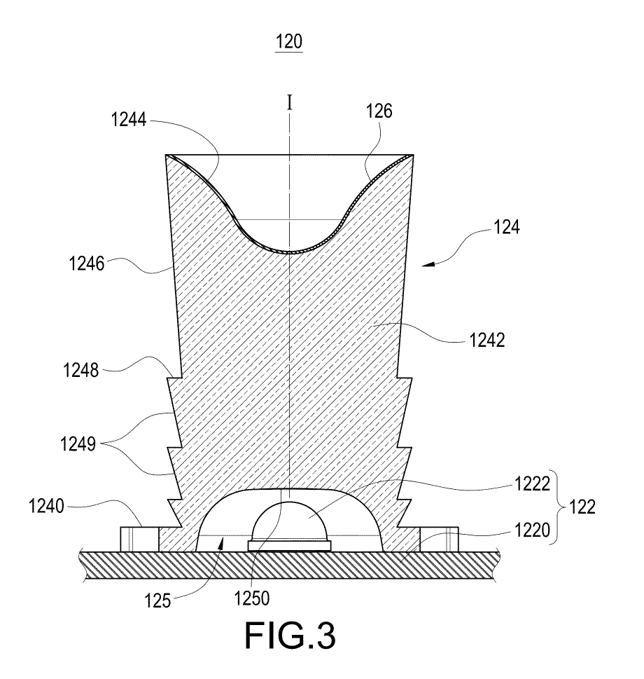

The housing 110 is preferably made of metal material or metal material coated with thermal conductivity material thereby to increase the rate of thermal conductivity. Alternatively, the housing 110 may be made of thermal plastic including at least a material with high thermal conductivity coefficient, such as metallic powder, graphite powder or ceramic powder, which can effectively remove heat generated by the lighting module 120. In addition, a plurality of fins (not shown) are radially extended from a circumferential wall of the housing 110 and physically connected thereon for fast removing heat generated by lighting module 120. Reference is made to FIG. 3, which is a cross sectional view of a lighting module according to a first preferred embodiment of the present invention. The lighting module 120 includes an illuminant unit 122, a light guide pillar 124 and a first reflecting member 126.

The illuminant unit 122 has an optical axis I and includes a circuit board 1220 and at least a light emitting diode (LED) 1222. The circuit board 1220 is disposed on the housing 110 (as shown in FIG. 2) and is provided with conductive traces (not shown) and soldering pads (not shown). The circuit board 1220 may be Printed Circuit Board (PCB), Metal Core PCB, ceramic PCB or composite material PCB for fast removing heat generated by the LED 1222. The LED 1222 is mounted on the circuit board 1220 and electrically connected thereon. In this embodiment, the number of the LED 1222 is, for example, one, and preferably high power LED. In the practical application, the LED 1222 may be high power multi-chip LED.

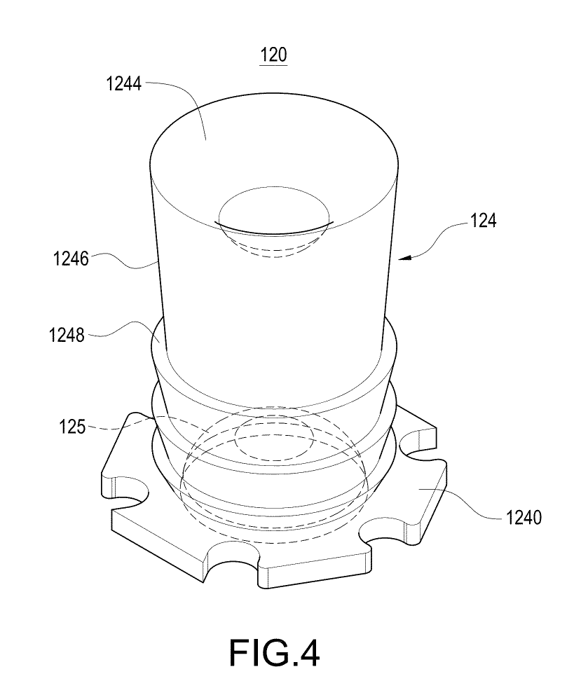

The light guide pillar 124 is made of optical transparency material, such as PMMA, synthetic resinous material, acryl, PC, PET, Polyolefines, glass or the composition of material mention above. With reference also to FIG. 4, FIG. 4 showing a perspective view of a light guide pillar according to a first preferred embodiment of the present invention. The light guide pillar 124 has a base 1240, a light guide part 1242 and a recess 125. The illuminant unit 122 is disposed on the base 1240 and a center axis of the light guide pillar 124 is coincided with the optical axis I of the illuminant unit 122.

The light guide part 1242 is extended from the base 1240 along the optical axis I and an extending end of the light guide part 1242 has a top surface 1244. The top surface 1244 is concave toward the base 1240 and of arc-shape, and a curvature of the top surface 1244 is continuous. In addition, a tangent of the top surface 1244 through which the optical axis I passes is substantially perpendicular to the optical axis I for reflecting light impinging the top surface 1244. In this embodiment, the light guide part 1242 is of cylindrical shape. However, in the practical application, the light guide part 1242 may have any geometric shape. In addition, the diameter of the light guide part 1242 is progressively increased along a direction far away from the base 1240 such that the light guide part 1242 has a trapezoid shaped profile to increase the rate of light transmit inner the light guide part 1242 based on totally internal reflection (TIR). The light guide part 1242 further includes a light-emitting surface 1246 which is adjacent to the base 1240 and the top surface 1244.

The recess 125 is concave toward the light guide part 1242 from the base 1240 and formed a light-incident surface 1250. The LED 1222 is disposed on the recess 125 and injects light into the light guide part 1242 from the light-incident surface 1250, and the light guide pillar 124 covers the LED 1222.

In addition, a plurality of planes 1248 are defined at a transverse direction substantially perpendicular to an extending direction of the optical axis I of the light guide part 1242 which is adjacent to the base 1240. The diameter of each plane 1248 is equal to the diameter of the top surface 1244, and the intervals between each two adjacent planes 1248 are progressively increased along a direction far away from the base 1240. In this embodiment, the number of the planes 1248 are, but not limited to, three. A connecting surface 1249 is adjacent each two planes 1248, and the distance between the connecting surface 1249 and the optical axis I is progressively decreased when the connecting surface 1249 is gradually closed to the base 1240 for obliquely adjacent to each two planes 1248. Namely, the connecting surface 1249 is adjacent an edge of the plane 1248 far away from the base 1240, and then progressively decreased the distance between the connecting plane 1249 and the optical axis I and adjacent to another plane 1248 close to the base 1240. The planes 1248 and the connecting surfaces 1249 can effectively increase the ratio of light refracting from the light guide part 1242 near to the base 1240.

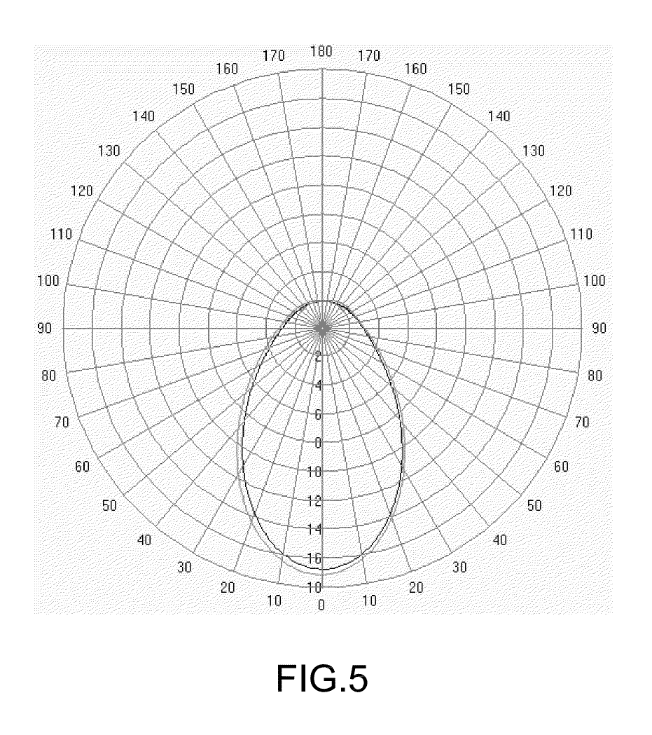

Partial light emitted by the LED 1222 is directly refracted from the connecting surface 1249 or the plane 1248, partial light travelling in the light guide part 1242 is then generally transported along the extension of the light guide part 1242 towards the top surface 1244 based on total internal reflection, and refract from the top surface 1244. The luminous distribution of light passing through the light guide pillar 124 is shown in FIG. 5.

With reference again to FIG. 3, the first reflecting member 126 is disposed on the top surface 1244, such that a portion of light impinging the top surface 1244 is reflected. The first reflecting member 126 may be a metal film or synthetic resinous material, the synthetic resinous material preferably has white, silver or other colors with preferably reflecting effect. In the practical application, the color of the first reflecting member 126 may be adjusted according to different situations or limitation. Alternatively, the first reflecting member 126 may be formed of optical transparency resin, such as UV resin, and is of transparent (or at least translucent), and the refractive index of the first reflecting member 126 is smaller than the refractive index of the light guide pillar 124.

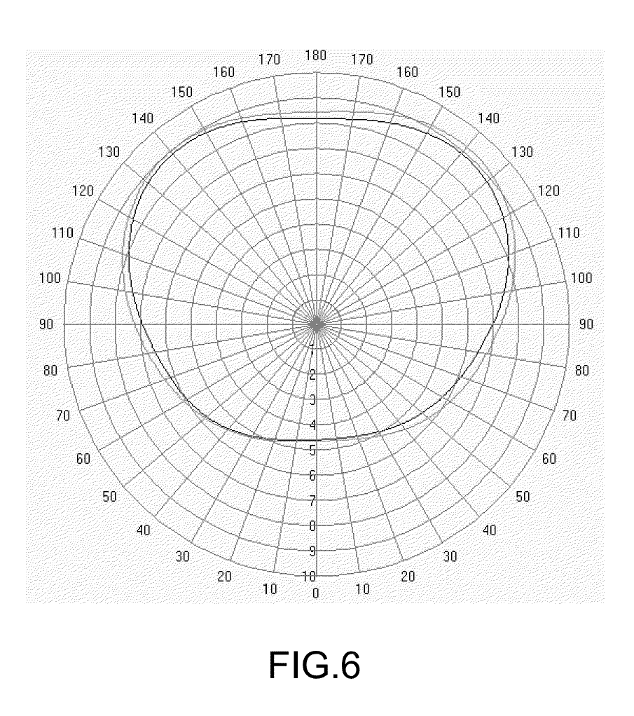

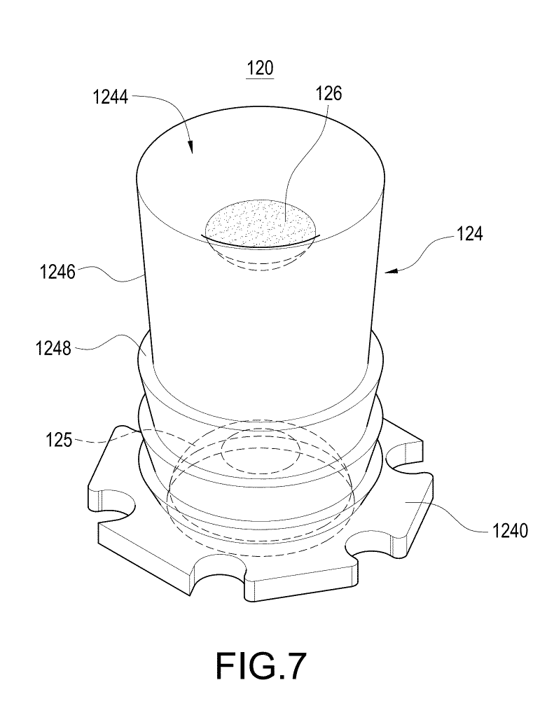

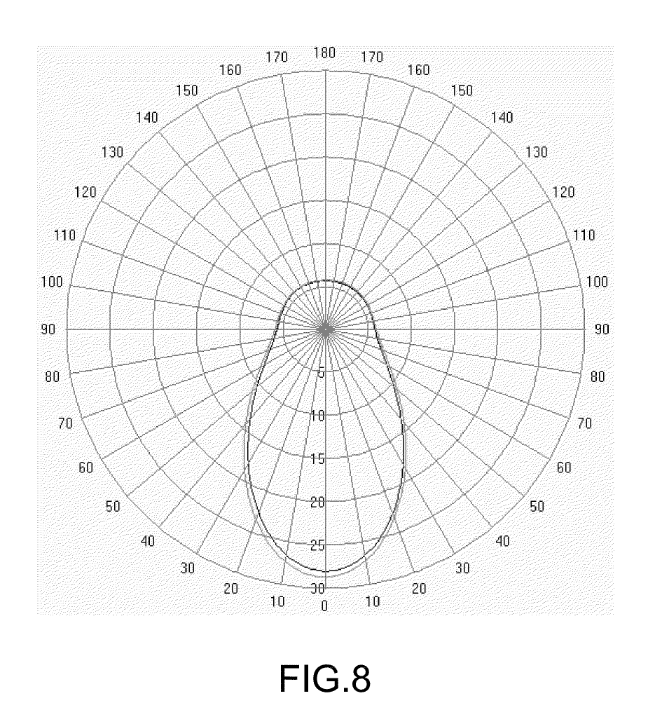

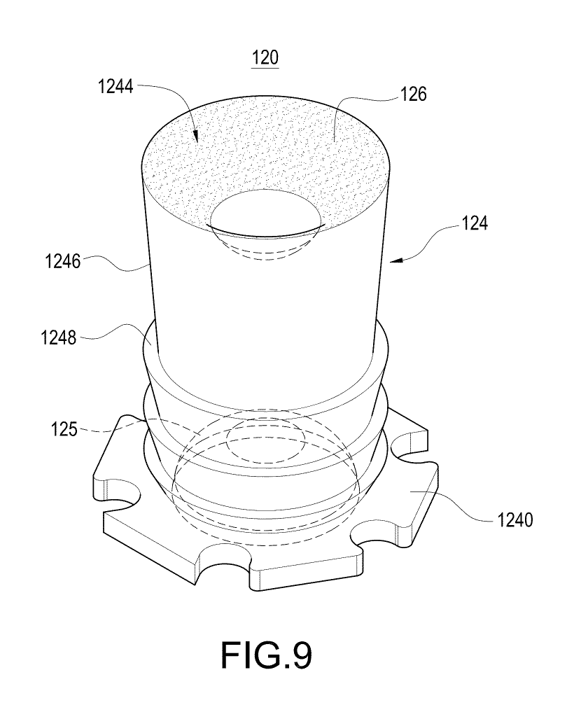

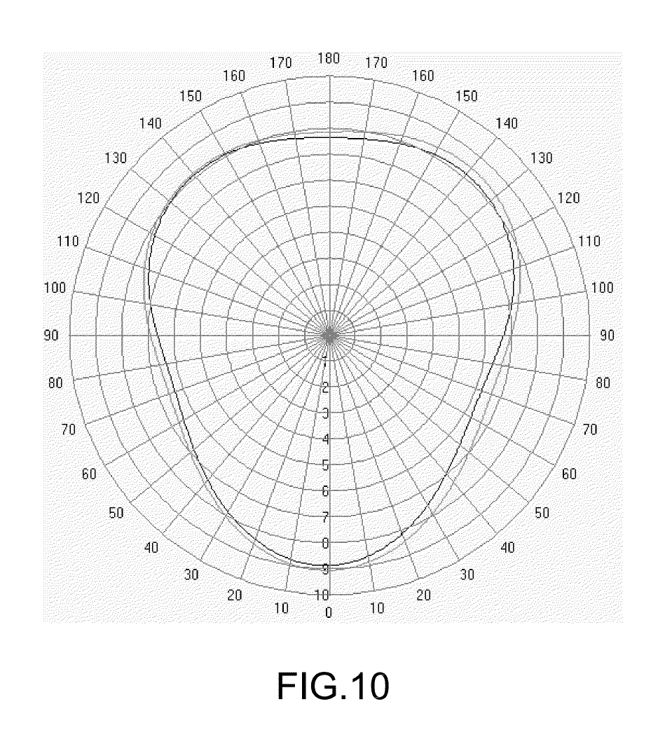

In this embodiment, the first reflecting member 126 completely covers the top surface 1244 for reflecting light impinging the top surface 1244, and the corresponding luminous distribution of light passing through the light lighting module 120 is shown in FIG. 6. Comparing to the FIG. 5, the first reflecting member 126 can reflect light impinging the top surface 1244 to change travelling route of light and then light can emit from the light-emitting surface 1246 to enlarge light-emitting angle. In addition, the first reflecting member 126 may dispose on a center part of the top surface 1244, namely, the first reflecting member 126 covers the center part of the top surface 1244, thereby a light transmissive area is formed at the circumference of the top surface 1244 (and around the center part), as shown in FIG. 7, for reflecting light impinged to the center part of the top surface 1244, and FIG. 8 schematically shows luminous distribution. Alternatively, the first reflecting member 126 may dispose on a circumference of the top surface 1244, thereby a transmissive area is formed at a center of the top surface 1244, as shown in FIG. 9, for reflecting light impinged to the circumference of the top surface 1244, and FIG. 10 schematically shows luminous distribution.

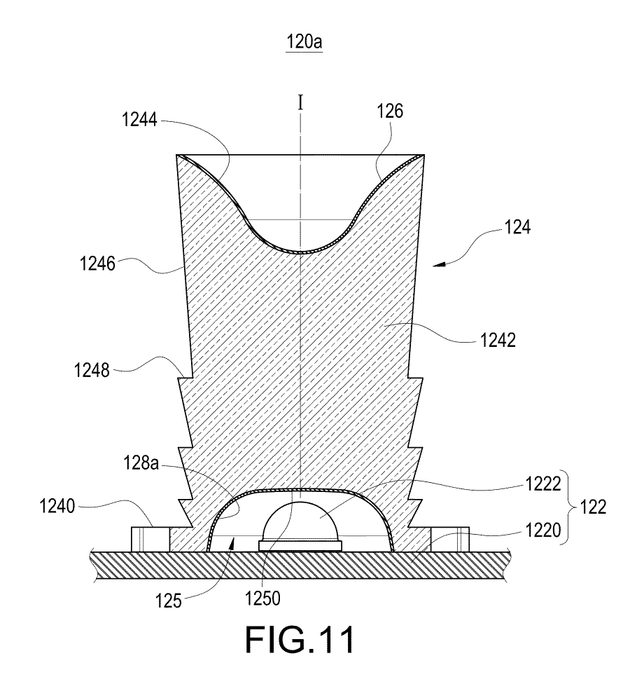

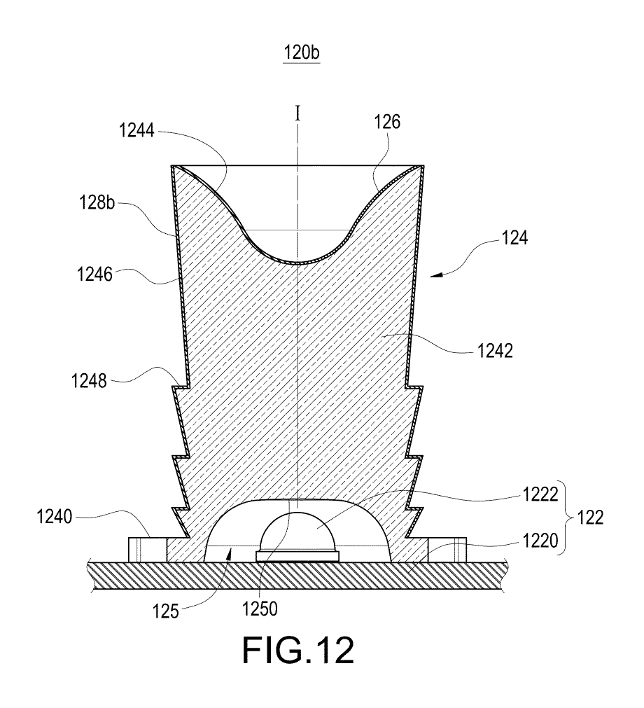

Furthermore, the light module 120 includes a phosphor uniformly distributed within the light guide pillar 124, thereby light travelling in the light guide pillar 124 is converted by the phosphor to generate a wavelength-converted light, and the color may be adjusted according to different situations or limitation. In a variation embodiment of the present invention, the lighting module 120a includes a phosphor layer 128a, as shown in FIG. 11. The phosphor layer 128a is disposed on the light-incident surface 1250 of the light guide pillar 124 for allowing light passing through the light-incident surface 1250 to generate a wavelength-converted light. In another variation embodiment of the present invention, the lighting module 120b includes a phosphor layer 128b, as shown in FIG. 12. The phosphor layer 128b is disposed on the light-emitting surface 1246 of the light guide pillar 124 for allowing light passing through the light-emitting surface 1246 to generate a wavelength-converted light.

With reference again to FIG. 1, FIG. 2 and FIG. 3, the shell 130 is assembled with the housing 110 and encloses the lighting module 120 such that the lighting module 120 is arranged between the shell 130 and housing 110. The shell 130 is made of transparent material, such as resin, plastic or glass. In this embodiment, the shall 130 is of ball shape. In the practical application, the shall 130 may be of candlelight shape or other special shape. In addition, the shell 130 may be selected to be transparent, translucent or matted, and the translucent shell 130 can be classified into two variation embodiments, the one is that an external surface 132 of the shall 130 is matted, another is that an inner surface 134 of the shall 130 is matted.

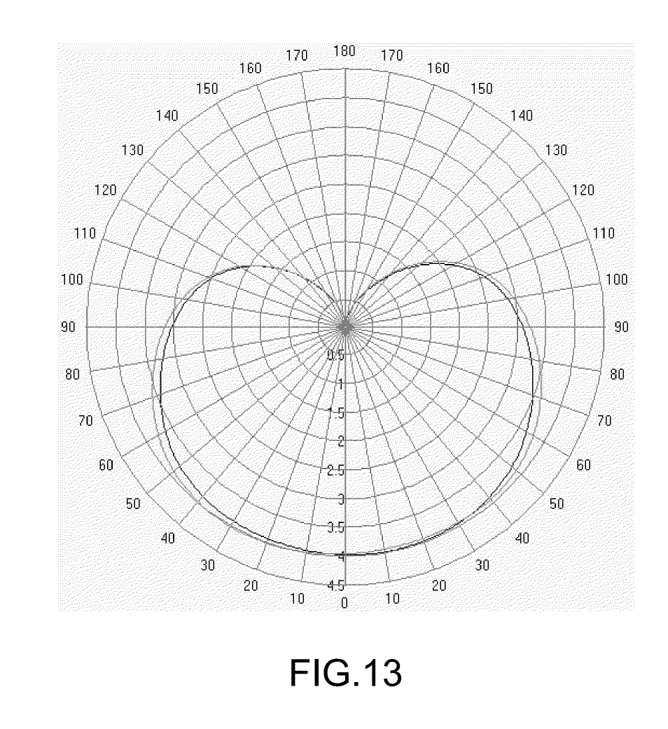

Light emitted by the LED 1222 is impinged the light guide part 1242 through the light-incident surface 1250 when the illuminant unit 122 is lighting up. Part of light is directly emitting from the light-emitting surface 1246 because the light-incident angles of the light are smaller than TIR angle. And part is then generally guided to top surface 1244 by guiding with the light guide part 1242 and reflected by the first reflecting member 126 covered on the top surface 1244 and emitting from the light-emitting surface 1246 because the light-incident angle of the light are equal to or larger than the TIR angle. The light emitted from the light-emitting surface 1246 is then passed through the shell 130 and guided outside, and the corresponding luminous distribution is shown in FIG. 13. Since the profile of the light guide part 1242 is of trapezoid, light having light-incident angle larger than or equal to the TIR angle is then reflected within the light guide part 1242 without loss, until the light impinge the top surface 1244 and reflects by the first reflecting member 126 such that the light emits from the light-emitting surface 1246. With reference again to FIG. 1 and FIG. 2, the conductive connector 140 is physically connected to the housing 110 and opposite to the shell 130. The conductive connector 140 is adapted to be screwed into the socket of ordinary lamp and can be electrically connected to an AC power source. The conductive connector 140 is, but not limited to, E26 or E27 connector.

In addition, the circuit board 1220 can include a reflecting layer 1221, as shown in FIG. 2. The reflecting layer 1221 may be a material having high-reflectance, such as, filter made of chromium, aluminum, or a plastic film coated or stuck with high-reflectance material.

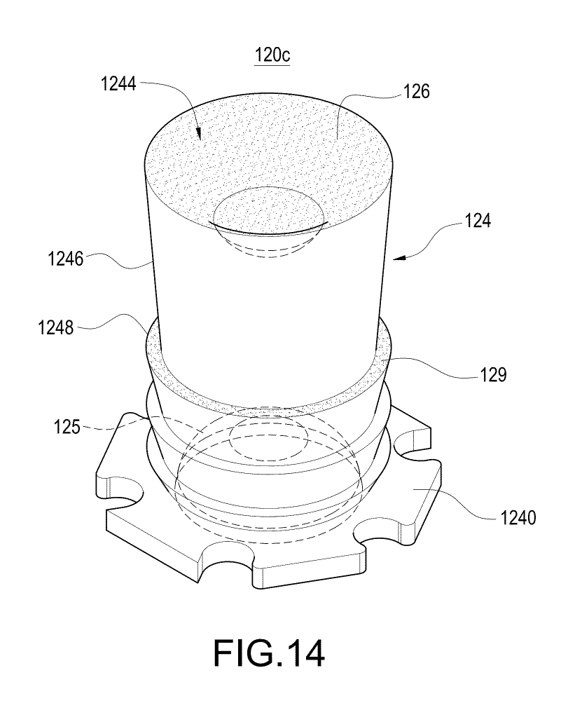

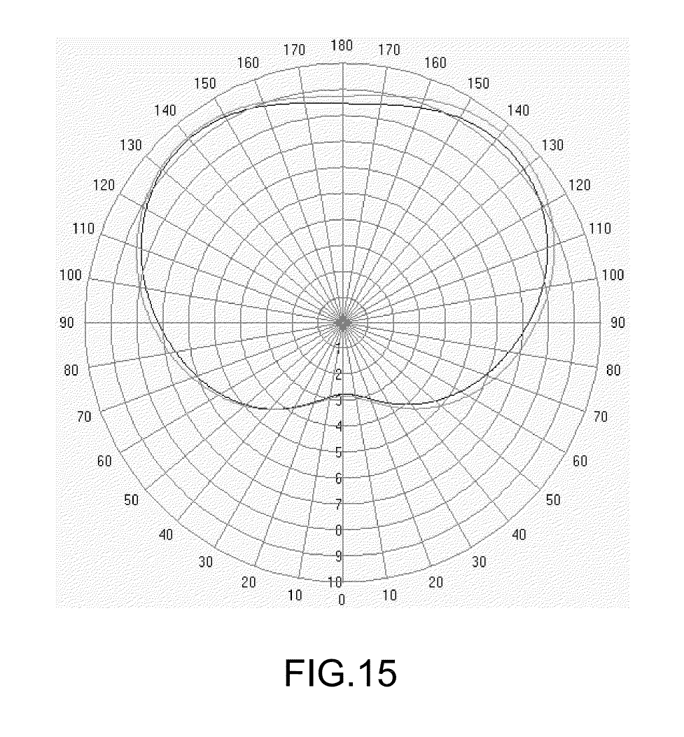

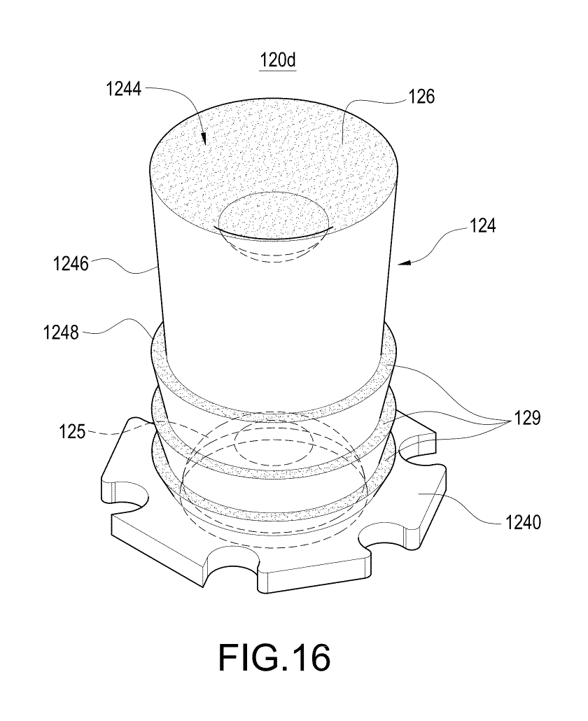

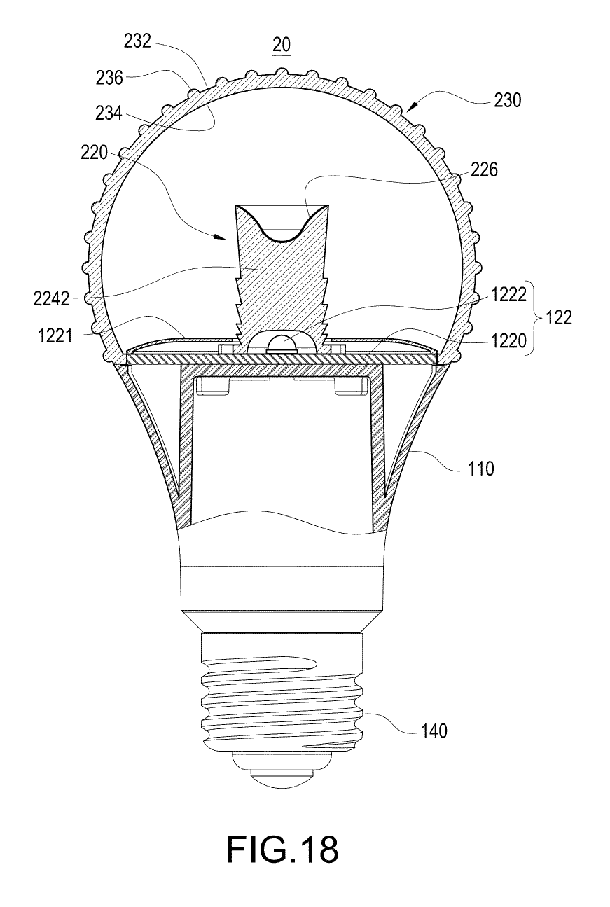

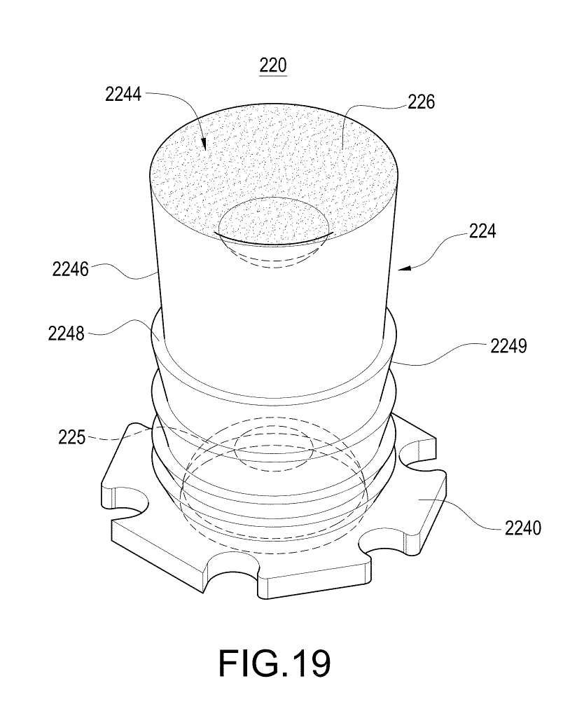

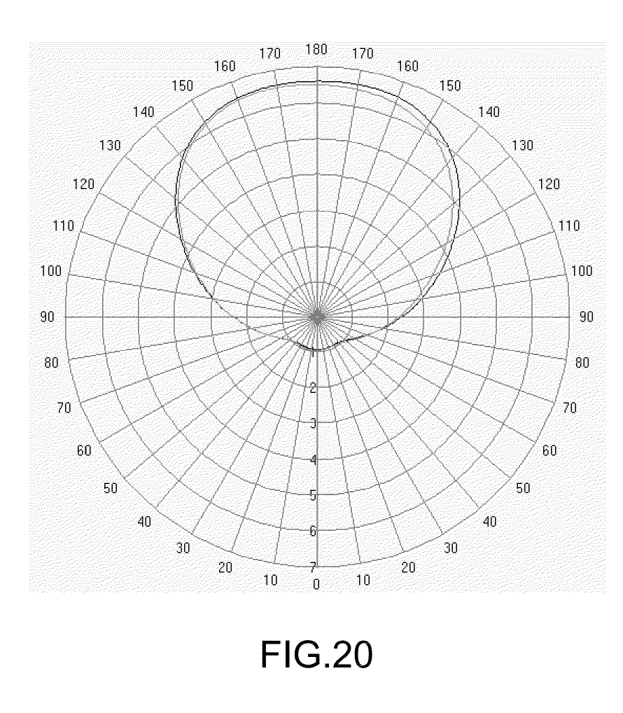

Reference is made to FIG. 14, which is a perspective view of a light guide pillar according to a fourth embodiment of the present invention. The lighting module 120c is similar to the first embodiment mentioned above. The difference is that the lighting module 120c further includes a second reflecting member 129. The second reflecting member 129 is disposed on at least a plane 1248 for reflecting light impinging the plane 1248 and smoothing light-emitting angle. The second reflecting member 129 may be a metal film or synthetic resinous material, the synthetic resinous material preferably has white, silver or other colors with preferably reflecting effect. In the practical application, the color of the second reflecting member 129 may be adjusted according to different situations or limitation. Alternatively, the second reflecting member 129 may be formed of optical transparency resin, such as UV resin, and is of transparent (or at least translucent), and the refractive index of the second reflecting member 129 is smaller than the refractive index of the light guide pillar 124. In addition, the second reflecting member 129 and the first reflecting member 126 may be made of same or different material. In this embodiment, the second reflecting member 129 is, but not limited to, disposed on the plane 1248 close to the top surface 1244, and the luminous distribution of light passing through the lighting module 120c is shown in FIG. 15. In a variation embodiment of the present invention, the lighting module 120d includes a plurality of second reflecting member 129 respectively disposed on the planes 1248, as shown in FIG. 16 for reflecting light impinging the planes 1248. In this embodiment, the number of the planes 1248 and the second reflecting members 129 are all of the three, and the second reflecting members 129 are respectively disposed on the planes 1248. In another variation embodiment of the present invention, the second reflecting members 129 of a lighting module 120e are just disposed on two planes 1248, as shown in FIG. 16. In this embodiment, the number of the planes 1248 are three and the number of the second reflecting members 129 are two. The two second reflecting members 129 are disposed on each two planes 1248 and the two second reflecting members 129 are, but not limited to, disposed on the two planes 1248 close to the top surface 1244. Reference is made to FIG. 18 and FIG. 19, FIG. 18 is cross sectional view of an illuminant device according to a second preferred embodiment of the present invention, and FIG. 19 is a perspective view of a lighting module according to a fourth preferred embodiment of the present invention. The illuminant device 20 is similar to the first embodiment mentioned above. The difference is that the light guide pillar 224 and the shell 230 of the lighting module 220. The light guide pillar 224 of the lighting module 220 includes a base 2240 and a light guide part 2242, and the illuminant unit 122 is disposed on the base 2240. The light guide part 2242 is extended from the base 2240 along an optical axis I of an illuminant unit 122. An extending end of the light guide part 2242 has a top surface 2244, the top surface 2244 is concave toward the base 2240 and of arc-shape and the curvature of the top surface 2244 is continuous. The diameter of the light guide part 2242 is progressively increased along a direction far away from the base 2240 such that the profile of the light guide part 2242 is substantially of trapezoid. The light guide part 2242 further includes a light-emitting surface 2246 adjacent to the base 2240 and the top surface 2244. A first reflecting member 226 is disposed on the top surface 2244, and in this embodiment, the first reflecting member 226 completely covers the top surface 2244 to reflect light impinging the top surface 2244. In the practical application, the first reflecting member 226 may just cover the center part or the circumference of the top surface 2244. In addition, a plurality of planes 2248 substantially perpendicular to an extending direction of the optical axis I are disposed on the light guide part 2242 which is adjacent to the base 2240. The diameter of each plane 2248 is equal to the diameter of the top surface 2244, and the intervals between each two adjacent planes 2248 are progressively increased along a direction far away from the base 2240. In this embodiment, the number of the planes 2248 are, but not limited to, four. A connecting surface 2249 is adjacent to each two planes 2248, and the distance between the connecting surface 2249 and the optical axis I is progressively decreased when the connecting surface 2249 is gradually close to the base 2240 for obliquely adjacent to each two planes 2248. The LED 1222 is disposed on a recess 225 and the light guide pillar 224 covers the LED 1222. The LED 1222 emits light toward the light guide part 2242 and the luminous distribution of light passing through the light guide pillar 224 is shown in FIG. 20. The circuit board 1220 may further comprise a reflecting layer 1221, the reflecting layer 1221 may be a material having high-reflectance, such as, film made of chromium, aluminum, or a plastic film coated or stuck with high-reflectance material. The light module 220 may include at least a second reflecting member disposed on at least a plane 2248. The number of the second reflecting member may be one or more, and disposed on one of the plane 2248 or more of the planes 2248, its action and related description are the same as mentioned in the sixth, seventh and eighth embodiments, and the detail thereof is not described here for brevity. Furthermore, the lighting module 220 may further comprise a phosphor layer. The phosphor layer may disposed on a light-incident surface or the light-emitting surface 2246 of the light guide pillar 224, its action and related description are the same as mentioned in the fourth and fifth embodiments, and the detail thereof is not described here for brevity.

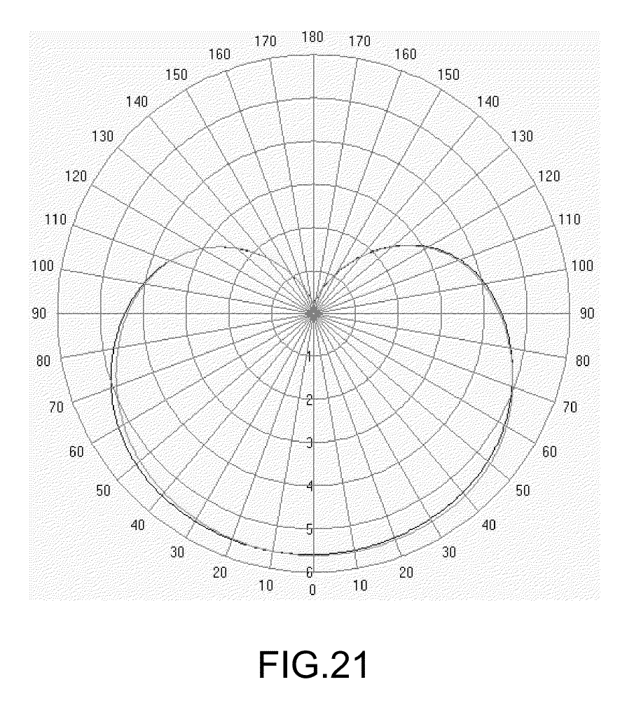

With reference again to FIG. 18, an external surface 232 of the shell 230 includes a plurality of microstructure 236, the microstructure 236 may be, but not limited to, preferably with circular shaped or hexagon shaped. Alternatively, the microstructure 236 may be disposed on an inner surface 234 of the shell 230. The microstructure 236 is used for eliminating light halo and promoting the illuminant effect of the illuminant device 20. The shell 230 is assembled with the housing 110 and encloses the lighting module 220, and the luminous distribution of light passing through the illuminant device 20 is shown in FIG. 21. To sum up, in the present invention, light guide pillar of the lighting module to change the travelling route of light, thereby enlarge the light-emitting angle of light passed through the light guide pillar and fit into ordinary luminaire.

Although the present invention has been described with reference to the foregoing preferred embodiment, it will be understood that the invention is not limited to the details thereof. Various equivalent variations and modifications can still occur to those skilled in this art in view of the teachings of the present invention. Thus, all such variations and equivalent modifications are also embraced within the scope of the invention as defined in the appended claims.

What is claimed is:

1. A lighting module comprising:
an illuminant unit having an optical axis and comprising at least a light emitting diode (LED);
a light guide pillar comprising a base, a light guide part extended from the base along the optical axis, an extension end of the light guide part having a top surface concave toward the base and being continuous; and
a first reflecting member disposed on at least portion of the top surface;
wherein a partial light emitted by the illuminant unit is travelling to the first reflecting member through the light guide pillar, the first reflecting member reflects the partial light such that the partial light emits from the light guide part.

2. The lighting module in claim 1, wherein the diameter of the light guide part is progressively increased along a direction gradually far away from the base.

3. The lighting module in claim 2, wherein the light guide pillar comprises a plurality of planes perpendicular to an extending direction of the optical axis, and intervals between each two planes are progressively increased along a direction far away from the base, a connecting surface is located between each two planes and the distance between the connecting surface and the optical axis is progressively decreased when the connecting surface is gradually close to the base.

4. The lighting module in claim 3, further comprising at least a second reflecting member disposed on at least the plane.

5. The lighting module in claim 1, further comprising a phosphor layer disposed on a light-emitting surface, the light-emitting surface connected to the base and the top surface.

6. The light module in claim 1, wherein the light guide pillar further comprises a recess, the recess is concave toward the light guide part from the base and formed a light-incident surface, the LED is disposed inner the recess.

7. The light module in claim 6, further comprising a phosphor layer disposed on the light-incident surface.

8. The light module in claim 1, wherein the illuminant unit further comprises a circuit board, and the LED is mounted on the circuit board.

9. The lighting module in claim 1, wherein the first reflecting member is disposed on a center part of the top surface.

10. The lighting module in claim 1, wherein the first reflecting member is disposed on a circumference of the top surface.

11. The lighting module in claim 1, wherein the first reflecting member completely covers the top surface.

12. The lighting module in claim 1, wherein the LED is high power LED or high power multi-chip LED.

13. An illuminant device comprising:
a housing;
a lighting module disposed on the housing, the lighting module comprising:
an illuminant unit having an optical axis and comprising at least an LED;
a light guide pillar comprising a base, a light guide part extended from the base along the optical axis, an extension end of the light guide part having a top surface concave toward the base and being continuous; and
a first reflecting member disposed on at least a portion of the top surface;
a shell assembled with the housing such that the lighting module is arranged between the shell and the housing; and
a conductive connector physically connected to the base and opposite to the shell;
wherein a partial light emitted by the LED is travelling to the first reflecting member through the light guide pillar, the first reflecting member reflects the partial light such that the partial light emits from the light guide part and transmits to and emits by the shell.

14. The illuminant device in claim 13, wherein diameter of the light guide part is progressively increase along a direction gradually far away from the base.

15. The illuminant device in claim 14, wherein the light guide pillar comprises a plurality planes perpendicular to an extending direction of the optical axis, the intervals between each two planes are progressively increased along a direction far away from the base, a connecting surface is located between each two planes and the distance between the connecting surface and the optical axis is progressively decreased when the connecting surface is gradually close to the base.

16. The illuminant device in claim 15, further comprising at least a second reflecting member disposed on at least a plane.

17. The illuminant device in claim 13, wherein the light module further comprises a phosphor layer disposed on a light-emitting surface, the light-emitting surface connected to the base and the top surface.

18. The illuminant device in claim 13, wherein the light guide part further comprises a recess, the recess is concave toward the light guide part from the base and formed a light-incident surface, the LED is disposed on the recess.

19. The illuminant device in claim 18, wherein the lighting module further comprises a phosphor layer disposed on the light-incident surface.

20. The illuminant device in claim 13, wherein a plurality of microstructures are disposed on an outer surface of the shell.

21. The illuminant device in claim 13, wherein the illuminant unit further comprises a circuit board, the LED is mounted on the circuit board.

22. The illuminant device in claim 13, wherein the first reflecting member is disposed on a center part of the top surface.

23. The illuminant device in claim 13, wherein the first reflecting member is disposed on a circumference of the top surface.

24. The illuminant device in claim 13, wherein the first reflecting member completely covers the top surface.

25. The illuminant device in claim 13, wherein the LED is high power LED or high power multi-chip LED.

26. The illuminant device in claim 21, further comprising a reflecting layer disposed on the circuit board.
